(19) United States
(12) Patent Application Publication
(10) Pub. No.: US 2010/0288600 A1
(43) Pub. Date: Nov. 18, 2010

(54) BILL HANDLING APPARATUS

(76) Inventor: Chris Robinson, Oldham (GB)

Correspondence Address: Woodard, Emhardt, Moriarty, McNett & Henry LLP, 111 Monument Circle, Suite 3700, Indianapolis, IN, 46204-5137, US

(21) Appl. No.: 12/779,398

(22) Filed: May 13, 2010

(30) Foreign Application Priority Data
May 16, 2009 (GB) 0908441.9

(51) Int. Cl. G07F 7/04

(52) U.S. Cl. 194/206

(57) ABSTRACT

Apparatus for the handling of bills in which the path of the bills is controlled to allow selective storage of the bills in different bill storage means.

The invention to which this application relates is apparatus for use in handling bills and banknotes and/or vouchers or tickets, (hereinafter referred to as bills) which may be provided by customers to the apparatus as payment for a service or product and/or provided by the apparatus to the customer, as change or as a win.

The provision of apparatus which allows bills to be input is well known. It is known to provide apparatus which when bills are placed into the apparatus are moved into a storage “box” which can subsequently be removed when full. Alternatively, apparatus is known in which bills are moved into a storage medium in the form of one or more rolls or reels on which the bills are held.

The applicant has realised that there is a need for the apparatus to be more flexible in terms of the bill storage systems which are available with regard to the handling of the bills and options which are available with respect to the same. The reason for this is that while bill storage boxes are suitable for apparatus which most typically receives bills but does not pay the same out it is increasingly the case that there is a demand for bills to be paid out. Equally while the holding of bills on recycling rolls or reels provides the ability for bills to be paid out, the storage capacity is limited.

The aim of the present invention is therefore to provide apparatus with greater flexibility in terms of the handling of the bills.

In a first aspect of the invention there is provided apparatus for the handling of bills, said apparatus including an inlet and outlet via which bills may selectively be input to and/or output from the apparatus and wherein said apparatus includes at least two bill storage means which may selectively be used for the storage of the bills therein.

In one embodiment at least one of the storage means is provided in a form so as to allow bills to be selectively dispensed therefrom.

In one embodiment bills which are input are selectively placed into one of the storage means in response to signals generated by control means included in the apparatus.

In one embodiment the control means detects the bill which is input and determines whether that bill is required by the storage means which is capable of dispensing bills. If it is required the bill is directed to said storage means. If it is not required then the bill is directed to the other of the storage means.

In one embodiment the path followed by the input bill to the said storage means is common along a portion of the path as the bill passes through bill validation and identification apparatus and thereafter the path splits and diverges towards one or the other of the storage means.

In one embodiment the inlet and outlet are provided by a common aperture in an interface.

In one embodiment the directing of the bill between the first and second storage means is achieved via selective operation of a directing means, hereinafter referred to as a paddle, said paddle, in a first position, completing a path to a first storage means and, in a second position, completing a path to the other of the storage means.

Typically the positioning of the paddle is controlled by the control means and is dependent upon the type of bill detected and/or condition of at least one of the storage means. Typically the paddle is held in a default position to define a path towards one of the storage means.

In one embodiment the storage means which is capable of dispensing bills comprises at least one reel or belt on which said notes are stored and which can be controlled to allow one or more bills of a known denomination to be dispensed so as to allow a monetary value to be dispensed as required by the apparatus. Typically the monetary value represents change to be paid out to a user of the apparatus or a win to be paid out to the user.

Typically a bill is directed to the said storage means capable of dispensing bills when with respect to detection of at least one parameter of the bill, such as it's value, and/or when it is detected that that storage means contains a number of said bills which is below a predetermined threshold. Typically the threshold is that which is decided as being necessary to allow a required range of monetary values to be dispensed from the apparatus. If the said payout storage means is sufficiently stocked then the bills are passed along the path to the other storage means which typically is a box in which the bills are held until the storage box is emptied or removed from the apparatus by authorised personnel.

A specific embodiment of the invention is now described with reference to the following drawings wherein;

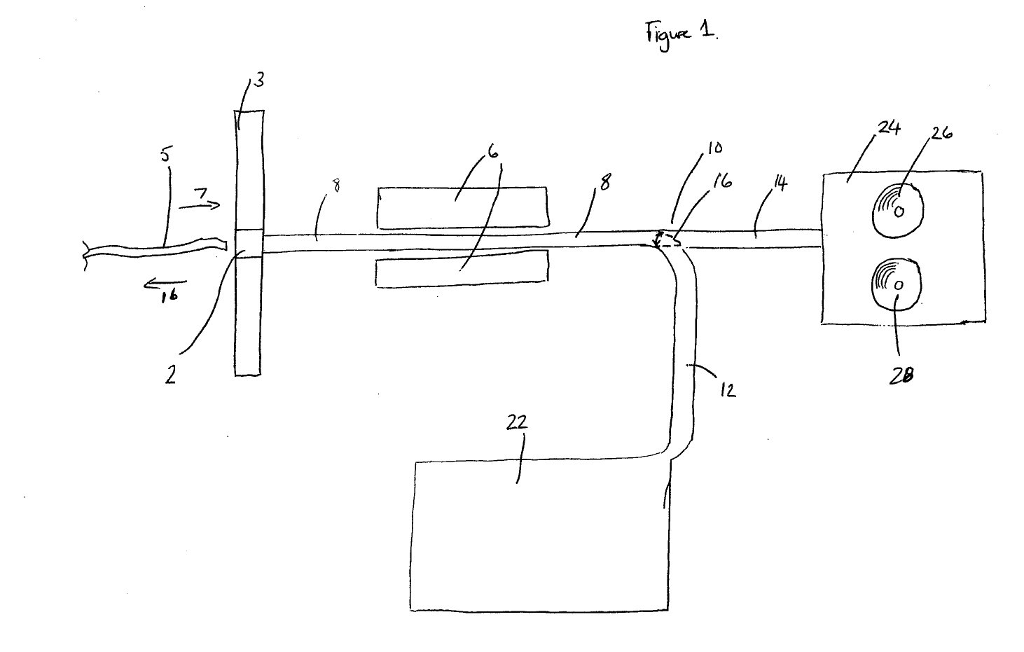

FIG. 1 illustrates a schematic diagram of the invention in accordance with one embodiment of the invention; and

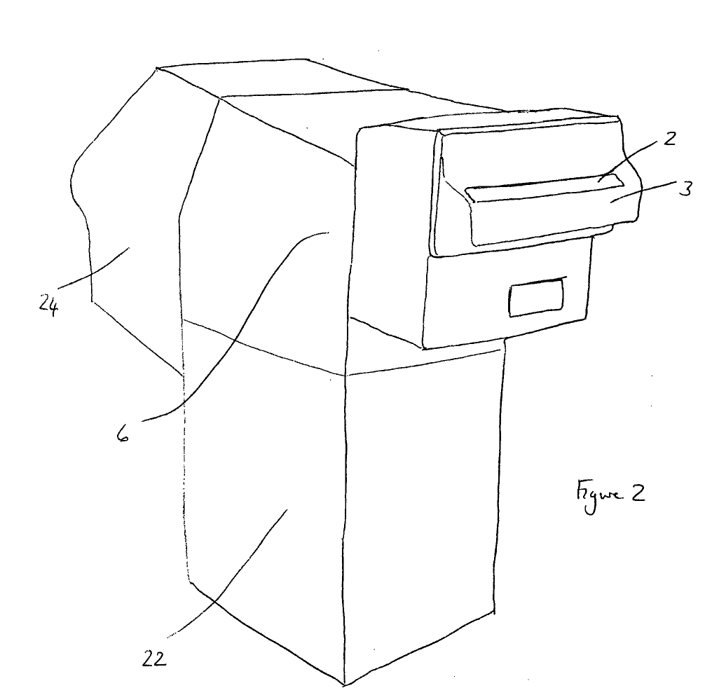

FIG. 2 illustrates an embodiment showing implementation of one embodiment of the invention.

Referring firstly to FIG. 1, there is illustrated in a schematic manner, an implementation of one embodiment of the invention.

In this case, there is provided an aperture or opening which acts as an inlet and outlet 2 at a user interface 3, typically the front face of the apparatus which is provided for receiving bills and selected payout out bills. The apparatus may be provided as part of amusement, leisure and/or gambling apparatus and/or payout apparatus such as, for example, for car parking tickets. When the same operates as an inlet, a user can place a bill 5 therein and feed means move the bill 7 along a path to bill validation and identification means. The bill validation and identification means 6 is typically of a standard form and therefore are not described in detail here other than to state that the purpose of the same is to ensure that the bill which has been input to the apparatus is valid and is of a form which can be accepted by the apparatus and also, to identify the value or denomination of the bill. If the bill is accepted by this apparatus 6 then the same continues along path 8 to a junction 10. At this junction, there is defined a first path 12 and a second path 14. At any given time, only one of the paths is available for the bill to travel along and this is defined by the selective movement of a directing means in the form of paddle 16. The paddle can be controlled to move to either of two the positions so as to open or close the respective paths. In one embodiment the paddle may be biased towards a default position in which one of the paths, typically the path to the first storage means, is normally open and the paddle is only moved to the other position when it is desired that the other path is open so as to stock the second storage means 24 or to allow a payout of bills from the second storage means 24 so the second storage means is controllable to receive input bills, store the same, and the selectively pay bills out therefrom.

The movement of the paddle is controlled by a control system which will be described in greater detail subsequently. One of the paths 12 leads to a storage box or container 22 in which the bills can be stored and the box, typically, can be emptied and/or removed from time to time to allow the bills to be moved therefrom and transported to a secure store area and the storage means 22 is subsequently placed back into the apparatus to be filled with further bills. The other path 14 leads to a second storage means 24 in the form of one or more reels 26, 28. Each of the reels has a belt or web wound there around and bills can be stored in sequence between the layers of the said belt on the wheels. Typically the position of each of the bills on the belt or web is known, as is the value of the bills held in the storage means at that time. A more detailed description of this type of storage means is provided in the applicant's co-pending application number GB0820089.1, the contents of which are incorporated herein by reference. From this particular storage means 24 bills can be dispensed, as well as accepted, with the bills which are dispensed passing in the reverse direction along the paths 14, 8 and out of outlet 2 to a user of the apparatus, typically as change or as a monetary win, as indicated by arrow 16, if, for example, the apparatus is incorporated in gaming machines.

This storage means 24 may also be removed from time to time although it is envisaged that the same will not become full due to the control of the same as will now be described.

With the two storage means for bills available, at least one of which can be used to dispense as well as accept bills, then the functionality and flexibility of the apparatus is greatly improved over conventional forms of the same.

In order to control the movement of the bills within the apparatus then the control means receives data from the bill validation and identification apparatus to firstly, ensure that the bill is valid and secondly, to identify the monetary value of the bill. With this information, the control means then compares this with the identity of bills which are stored in the second storage means 24. If it is found that bills with the same value as the said bill in question, are already present as required in the storage means with respect to predetermined requirements in terms of the number of bills and/or the denomination of bills stored therein, then the bill which is passing through the apparatus at that time, the paddle 16 is moved to a position to define path 12 and the bill will be passed to the first storage means 22 and stored therein for subsequent removal of the storage box in due course. However, if the control means identifies that an insufficient number of the bills of the type identified are stored in the second storage means 24 at that time, then there is a need for the bill passing through the apparatus to be stored in the second storage means 24. This could be, for example, to allow sufficient bills of that type to be present to allow a pay out to be made. In this case the paddle 16 is moved to define path 14 and the bill passing through the apparatus will be passed to the second storage means 24 and stored therein in an index position so that the same can be subsequently retrieved. This therefore means that the bills, and the type of bills, stored in the second storage means 24 can be kept in a required condition by the selective movement of input bills to said second storage means. If the bills are not required in the second storage means 24 then the same will be moved along the path to the first storage means 22.

As and when a payment is required to be made out to a user of the apparatus then the control means will control the second storage means to present the bill or number of bills therefrom which are required to meet the monetary value of the pay out and then these bills can be fed in the reverse direction along the path 14, 8 to the outlet aperture of the apparatus to be paid out.

FIG. 2 illustrates a practical implementation of the schematic diagram of FIG. 1 and shows the inlet outlet aperture 2 located on a user interface which forms the front face of the apparatus. The remainder of the apparatus leading from the interface, is typically located within the housing of a larger item and includes, in this arrangement, the bill validation and identification apparatus leading to first storage means 22 and the second storage means 24. The paddle 16 is located so as to allow the particular path and hence the storage means which is to be used, to be selected for the bill once the same has passed beyond the validation apparatus.

Typically, the second storage means 24 is provided with a docking connector so as to allow the same to be locked in automatically to the bill validation apparatus and allow the same to be automatically connected mechanically and typically more importantly, electronically to allow data to be transferred between the second storage means and the control means of the apparatus.

In one embodiment, the paddle 16 is provided in a default position such that in that position bills are moved to the first storage means along that path and, if the bill is to be moved to the second storage means then power is required to be passed to the paddle to move the same.

In one embodiment, bills are selectively positioned in the second storage means such that those bills which are of a denomination which is most commonly paid out are grouped together.

1. Apparatus for the handling of bills, said apparatus including an inlet and outlet via which bills may be selectively be input to and/or output from the apparatus and wherein said apparatus includes at least two bill storage means which may selectively be used for the storage of the bills therein.

2. Apparatus according to claim 1 wherein at least one of the storage means is provided in a form so as to allow bills to be selectively dispensed therefrom.

3. Apparatus according to claim 1 wherein bills which are input are selectively placed into one of the storage means in response to control means included in the apparatus.

4. Apparatus according to claim 3 wherein the control means detects the type of bill which is input and determines whether that bill is required by the storage means which is capable of dispensing bills and, if so, the bill is directed to said storage means and, if not, the bill is directed to the other of the storage means.

5. Apparatus according to claim 1 wherein the path followed by the input bill to the said storage means is common along a portion of the path as it passes through bill validation and identification apparatus.

6. Apparatus according to claim 5 wherein following passage of the bill through the validation and identification apparatus, the paths split and each path directs a bill towards one or other of the storage means respectively.

7. Apparatus according to claim 1 wherein the inlet and outlet are provided by a common aperture in front face of the apparatus.

8. Apparatus according to claim 1 wherein the directing of the bill between first and second storage means is achieved via selective operation of a directing means which, in a first position, completes a path to one storage means and, in a second position, completes a path to the other of the storage means.

9. Apparatus according to claim 8 wherein positioning of the directing means is controlled by control means and is dependent upon at least one parameter of the detected input bill and/or condition of at least one of the storage means.

10. Apparatus according to claim 8 wherein the directing means is held in a default position to define a path towards one of the storage means.

11. Apparatus according to claim 1 wherein the storage means capable of dispensing bills comprises at least one reel or belt on which said bills are stored and which can be controlled to allow one or more bills of known denomination to be dispensed so as to allow a monetary value to be dispensed by the apparatus.

12. Apparatus according to claim 11 wherein the monetary value represents change to be paid out to a user of the apparatus or a win to be paid out to the user.

13. Apparatus according to claim 1 wherein an input bill is directed to the said storage means capable of dispensing bills when it is detected that that storage means contains a number of said bills which is below a predetermined threshold.

14. Apparatus according to claim 13 wherein the threshold is that which is decided as being necessary to allow a required range of monetary values to be dispensed to a user.

15. Apparatus according to claim 13 wherein if the said storage means is sufficiently stocked with bills then any further input bills are passed along a path to the other storage means.

16. Apparatus according to claim 15 wherein the other storage means is in the form of a storage box which can be selectively removed and/or emptied of bills stored therein.
